(19) United States
(12) Patent Application Publication
(10) Pub. No.: US 2023/0004358 A1
(43) Pub. Date: Jan. 5, 2023

(54) METHODS AND APPARATUS TO IMPROVE PERFORMANCE OF ENCRYPTION AND DECRYPTION TASKS

(71) Applicant: Intel Corporation, Santa Clara, CA (US)

(72) Inventors: Bhushan Parikh, Queen Creek, AZ (US); TJ O'Dwyer, Co. Tipperary (IE); Valerie Parker, Portland, OR (US); Stephen Palermo, Chandler, AZ (US)

(21) Appl. No.: 17/942,995

(22) Filed: Sep. 12, 2022

(51) Int. Cl. G06F 7/72; H04L 9/30; H04L 9/34

(52) U.S. Cl. CPC G06F 7/722; G06F 7/728; H04L 9/3013; H04L 9/3066; H04L 9/34

(57) ABSTRACT

Methods, apparatus, systems, and articles of manufacture are disclosed. An example apparatus includes: interface circuitry to receive a first value and a second value; selector circuitry to select a first subset of bits and a second subset of bits from the first value; multiplier circuitry to: multiply the first subset to the second value during a first compute cycle; and multiply the second subset to the second value during a second compute cycle; left shift circuitry to perform a bitwise shift with a product of the first subset and the second value during the second compute cycle; adder circuitry to add a product of the second subset and the second value to a result of the plurality of bitwise shift operations during the second compute cycle; and comparator circuitry to determine the result of the modular multiplication based on a result of the addition during the second compute cycle.

### FIELD OF THE DISCLOSURE

This disclosure relates generally to encryption and decryption, more particularly, to methods and apparatus to increase encryption and decryption tasks.

### BACKGROUND

Encryption refers to the process of representing data in a format that hides underlying information. In many examples, encryption can be used to provide security in a computer system. For example, a user device may store sensitive information (e.g., financial data, personal contact data, etc.) that needs to be sent across a network to a second device (e.g., a server that processes online purchase). The user device may encrypt the sensitive information before transmitting it over the network so that only devices with secret decryption data can reformat the encrypted message and obtain the sensitive information. In doing so, any malicious actor that does not have the secret key (decryption data) would be unable to the underlying sensitive information, even if the malicious actor intercepted the encrypted message during its transit over the network.

### BRIEF DESCRIPTION OF THE DRAWINGS

FIG. 1 is an illustrative example of position estimation for mobile devices.

FIG. 2A is an example block diagram of the device of FIG. 1.

FIG. 2B is an example block diagram of the server of FIG. 1.

FIG. 3 is an example block diagram of the multiplier circuitry of FIGS. 2A, 2B.

FIG. 4 is an illustrative example of operations performed by the frequency scaler circuitry of FIGS. 2A, 2B.

FIG. 5 is a flowchart representative of example machine readable instructions and/or example operations that may be executed by example processor circuitry to implement the example device and/or example server of FIGS. 2A, 2B.

FIG. 6 is a flowchart representative of example machine readable instructions and/or example operations that may be executed by example processor circuitry to implement the 25638 (25519<<1) domain modular multiplication of FIG. 5.

FIG. 7 is a block diagram of an example processing platform including processor circuitry structured to execute the example machine readable instructions and/or the example operations of FIG. 3 to implement the example device and/or example server of FIGS. 2A, 2B.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

A wide variety of encryption techniques can be used to provide security in a computer system. Some types of encryption techniques include flaws or exploits that, when identified and used by malicious actors, allow the recovery of sensitive information without the secret decryption information. In some examples, the identification and exploitation of a flaw in an encryption technique is referred to as breaking the encryption.

When a break occurs in an encryption technique used for security in a computer system, developers may change the encryption technique used in the computer system to re-establish security. In general, encryption techniques used by the computer security industry have become more complex over time. By increasing complexity, members of the computer security industry seek to develop new encryption techniques that are more difficult to break than previous encryption techniques, thereby ensuring computer systems stay secure for longer amounts of time.

As the complexity of encryption techniques increases, the computational resources and time required to perform encryption and decryption tasks have also increased. This increase in computational expense may negatively impact the performance of any device that uses encryption for security. For example, mobile devices such as smartphones, tablets, etc. frequently use encryption to securely transmit messages over a network but have limited amounts of power available to perform such tasks. Furthermore, because many devices may include general purpose hardware that is not specially designed to perform encryption. In some examples, an encryption technique may be so computationally expensive that a device lacks the resources to properly perform the encryption task as defined by a security protocol. In other examples, a device may be required to reduce the number of computational resources dedicated to other tasks so that additional computational resources can be used to perform the encryption task.

Example methods, systems, and apparatus described herein improve devices to perform computationally expensive tasks. Example frequency scaler circuitry obtains a power budget that describes an amount of power a given device is capable of using to perform the expensive task. Advantageously, the example frequency scaler circuitry selects, based on the power budget, a subset of processor cores within the device. The example frequency scaler circuitry assigns the selected subset of processor cores to perform the expensive task. The example frequency scaler circuitry increases the operating frequency of the selected subset of processor cores and, in turn, decreases the operating frequency of the remaining processor cores. As a result, a device that implements the example frequency scaler circuitry according to the teachings of this disclosure may perform a computationally expensive task (such as encryption) using less power and/or less time than previous solutions that ran the computationally expensive task on all cores without any adjustments to operating frequency.

One example of a complex encryption technique is x25519. x25519 refers to a set of encryption algorithms that use a mathematical function known as an Elliptic Curve Cryptography (ECC) 25519 curve according to the elliptic curve Diffie-Hellman (ECDH) key agreement scheme. Request For Comments (RFC) 8446, a popular security standard, requires that any device using Transport Layer Security (TLS) v1.3, a communication protocol, supports the x25519 algorithms.

Previous solutions that support the x25519 algorithms do so in a time consuming and computationally expensive manner. In big O notation, a computer science notation that describes an upper bound to how the execution time of an algorithm grows as the input size grows, many algorithms run in O(n³), resulting in long compute times. In a first example, one algorithm within x25519, x25519 Montgomery Point Multiplication, may require approximately 80,000 clock cycles to complete using techniques from previous solutions. As another example, Ed25519 Twisted Edwards Point Multiplication, which is another x25519 algorithm, may require approximately 70,0000 clock cycles to complete using techniques from previous solutions. The number of clock cycles are high in part because Modular Multiplication, an operation that occurs frequently within the x25519 algorithms, may require 19 or more compute cycles to perform each time techniques from previous solutions are used.

Advantageously, example methods, systems, and apparatus described herein reduce the number of clock cycles required to perform 25519 Modular Multiplication from 19 or more to 6. In turn, example devices that support x25519 algorithms according to the teachings of this disclosure may require approximately 27,000 clock cycles to perform x25519 Montgomery Point Multiplication and approximately 25,0000 clock cycles to perform Ed25519 Twisted Edwards Point Multiplication. As such, example devices that support x25519 algorithms according to the teachings of this disclosure may require less compute cycles to do so than previous solutions.

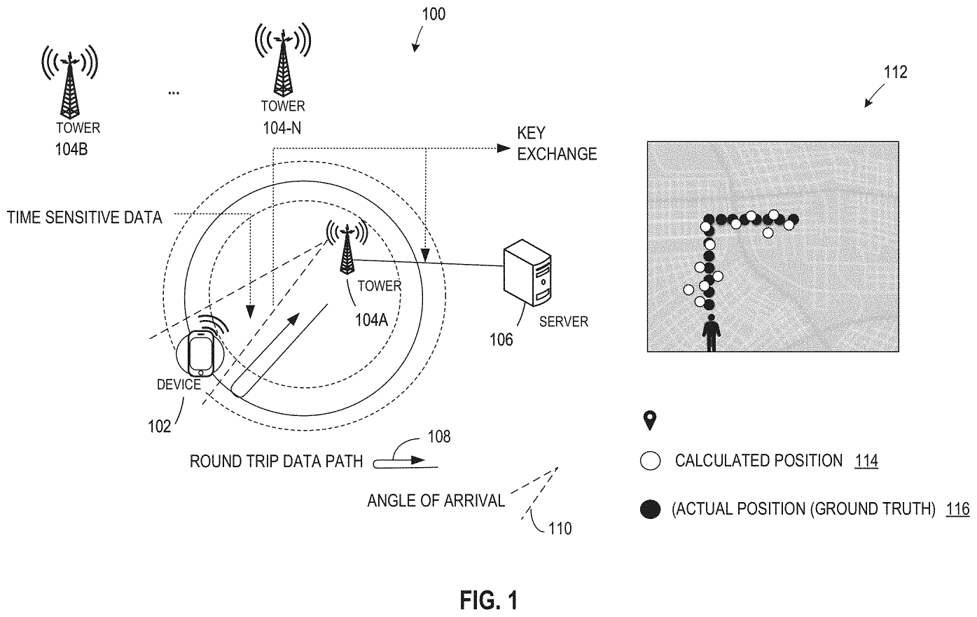

FIG. 1 is an illustrative example of position estimation for mobile devices. FIG. 1 includes an example computer system. The example computer system 100 includes an example device 102, example towers 104A, 104B, . . . , 104-n, an example server 106, an example round trip data path 108, and an example angle of arrival (AoA) 110. FIG. 1 also includes an example map 112. The example map 112 includes example calculated position points 114 and example actual position points 116.

The example computer system 100 determines the position of a device using 5G signal-cell based positioning techniques. Specifically, the example computer system 100 use the Long-Term Evolution (LTE) standard developed by the 3rd Generation Partnership Project (3GPP).

The example device 102 is any type of device that supports x2559 algorithms. The example device 102 may be, for example, a smartphone, tablet, wearable device, laptop, desktop, etc. In the illustrated example of FIG. 1, the example device 102 communicates using 5G-LTE. Furthermore, in FIG. 1, the example device 102 is an example of user equipment (UE) as defined in the 5G Radio Area Network (RAN) architecture.

When using 5G-LTE to determine position data, the example device 102 may generate sounding resource signal (SRS) data that estimates the quality of one or more communication channels at different frequencies. The example device 102 may generate the SRS data in response to instructions from the example tower 104A.

Each of the example towers 104A, 104B, . . . , 104-n is an example implementation of a 3GGP-compliant 5G base station. In some examples, a given example tower 104A may be referred to as a radio hardware unit (RU) and/or a distributed unit (DU) as defined by the gNodeB architecture of 5G-LTE compliant RANs. The example device 102 may communicate with the tower 104A as part of a massive multiple-input multiple-output (MIMO) architecture. In a massive multiple-input multiple-output (MIMO) architecture, each of example towers 104A, 104B, . . . , 104-n may include a “massive” number of antennas. As such, a given example tower 104A may receive data from a plurality of devices (including but not limited to the example device 102) and forward corresponding data to other towers 104B, . . . , 104-n, one or more destination devices, etc. The example computer system 100 may include any number of example towers 104A, 104B, . . . , 104-n.

The example server 106 is an example implementation of a centralized unit (CU) as defined by the gNodeB architecture of 5G-LTE compliant RANs. In some examples, the server 106 may be implemented within a Virtual Private Cloud (VPC). The example server 106 obtains SRS data from the tower 104A to calculate the position of the device 102. To calculate position information, the example server 106 may communicate with the example tower 104A to determine the AoA 110 of the SRS data. The AoA 110 data describes a direction from which the example tower received the SRS data from the example device 102. The example server 106 may use the AoA 110 in combination with additional information to calculate position data. Example information used to compute position may include, but is not limited a received signal strength indicator (RSSI), AoA data from other 5G-LTE compliant towers, etc. The example server may use any appropriate technique to calculate position data based on the available data. For example, the example device 102 may communicate with two or more of the example towers 104A, 104B, . . . , 104-n, causing the server 106 to receive two or more AoA values corresponding to each tower. In such examples, the server 106 may use the two or more AoA values to perform triangulation and calculate a position of the device 102.

The example server 106 may calculate new position data for the example device 102 to capture any movement of the example device 102. For example, the map 112 include actual position points 116, which describe where a user carrying the example device 102 is physically located within a city at different points in time. As the user moves, the example server 106 determines new position values as illustrated by the calculated position points 114.

Positioning techniques within the 5G-LTE protocol require the device 102 and the server 106 to communicate with one another. To enable communication, the device 102 and server 106 exchange keys and encrypt messages by executing x25519 algorithms. As used above and herein, a key refers to an amount of data that is used to accomplish encryption and decryption tasks. For example, a first device may encrypt sensitive information based on a key. In such an example, a second device may be required to know the value of the key to perform decryption. By exchanging keys through the x25519 algorithms, the example server 106 and device 102 jointly agree on a shared secret using an insecure channel.

The 5G-LTE standard defines the use of SRS data in a time sensitive manner. For example, in FIG. 1, the example tower 104A must receive SRS data within one second of when the example tower 104A transmits instructions to the example device 102 to generate the SRS data. If the example tower 104A receives SRS data later than one second after the instructions are sent, the SRS data is considered expired. In turn, the 5G-LTE standard may require the example server 106 obtain unexpired SRS data from the example tower 104A to calculate a position of the device 102. As such, the maximum distance that the example device 102 can be positioned away from the example tower 104A while still receiving 5G-LTE enabled position data is limited by the amount of time required for information to flow in the example round trip data path 108. The example round trip data path 108 includes transmission of instructions from the example tower 104A to the example device 102, the computation of the SRS data by the device 102, and the transmission of the SRS data from the device 102 to the tower 104A.

The illustrative example of FIG. 1 is an example of a practical application of the use of encryption within a computer system. Because the position of a device is sensitive information, the example device 102 and example server 106 seek to reformat the position data through encryption. The encrypted format hides the underlying information from any malicious actor that may have access to the example tower 104A or any other part of the communication network. As such, the example device 102 is required to encrypt the SRS data before transmission to the example tower 104A. The encryption of the SRS data, which includes multiple x25519 modular multiplication operations, is part of set of operations required to occur within one second to avoid the expiration of the SRS data. Advantageously, the example device 102 requires less clock cycles to compute x25519 modular multiplication operations than previous solutions. The improved efficiency of the example device 102 when performing encryption tasks may enable the example device 102 to satisfy a latency threshold. As an example, the example device 102 may meet the one second SRS expiration window while being positioned further away from the example tower 104A than other devices that use previous xx2519 modular multiplication.

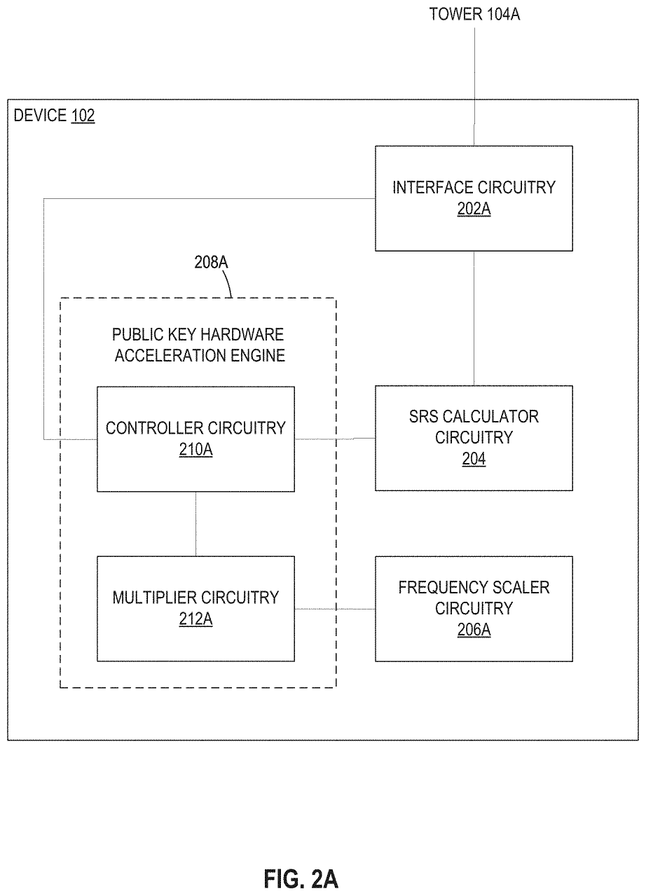

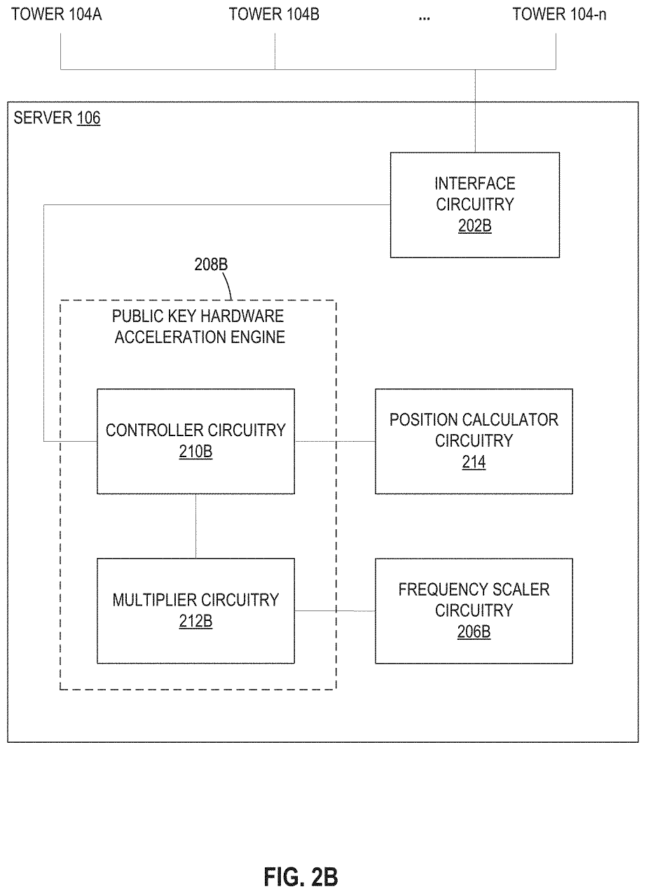

FIG. 2A is a block diagram of the example device 102 to perform computationally expensive tasks. The example device 102 of FIG. 2A may be instantiated (e.g., creating an instance of, bring into being for any length of time, materialize, implement, etc.) by processor circuitry such as a central processing unit executing instructions. Additionally or alternatively, the example device 102 of FIG. 2A may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2A may be implemented by microprocessor circuitry executing instructions to implement one or more virtual machines and/or containers.

FIG. 2A includes the example device 102 and the example tower 104A of FIG. 1. The example device 102 includes example interface circuitry 202A, example SRS calculator circuitry 204, example frequency scaler circuitry 206A, and an example public key acceleration engine 208A. The example public key acceleration engine 208A includes example controller circuitry 210A and example multiplier circuitry 212A.

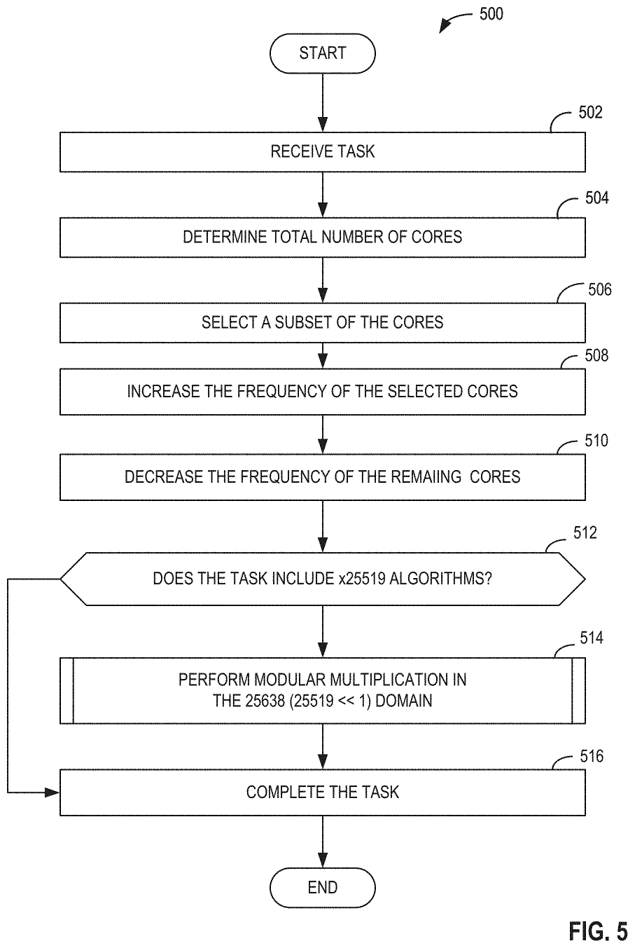

The example interface circuitry 202A enables communication between other components of the example device 102 and external devices. In some examples, the example interface circuitry 202A may implement one or more lower layers of the Open Systems Interconnection (OSI) model for communication protocols that may include, but are not limited to, WiFi®, Bluetooth®, Near Field Communication (NFC), etc. The example interface circuitry 202A receives a computationally expensive task from the external device. In some examples, the interface circuitry 202A is instantiated by processor circuitry executing interface instructions and/or configured to perform operations such as those represented by the flowchart of FIG. 5.

In FIG. 2A, the computationally expensive task is the encryption of SRS data. The example interface circuitry 202A may receive the request from instructions sent from the example tower 104A. The example interface circuitry 202A may receive the instructions in an encrypted format. In FIG. 2A, the example interface circuitry 202A also transmits encrypted SRS data to the example tower 104A. In such examples, the example interface circuitry 202A may be implemented by one or more 5G-LTE compliant antennas. The example interface circuitry 202A may additionally or alternatively implement one or more lower layers of the OSI model for a 5G-LTE compliant RAN.

The example SRS calculator circuitry 204 generates the SRS data to estimate the quality of the connection between the example interface circuitry 202A and the example tower 104A. The example SRS calculator circuitry 204 may use any appropriate technique as defined by the 5G-LTE standard to generate the SRS data.

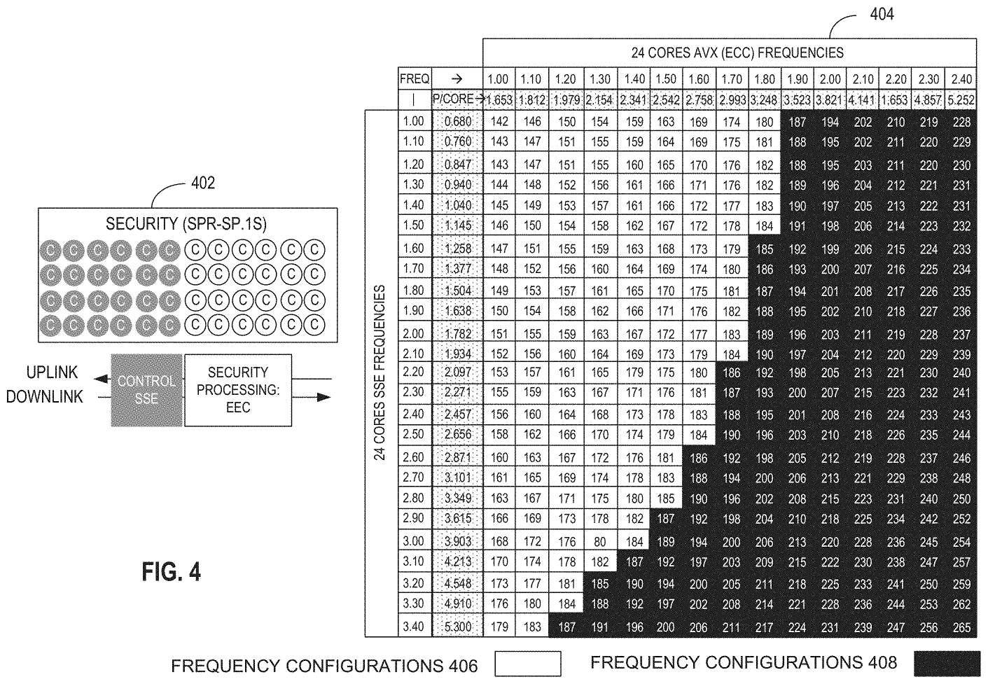

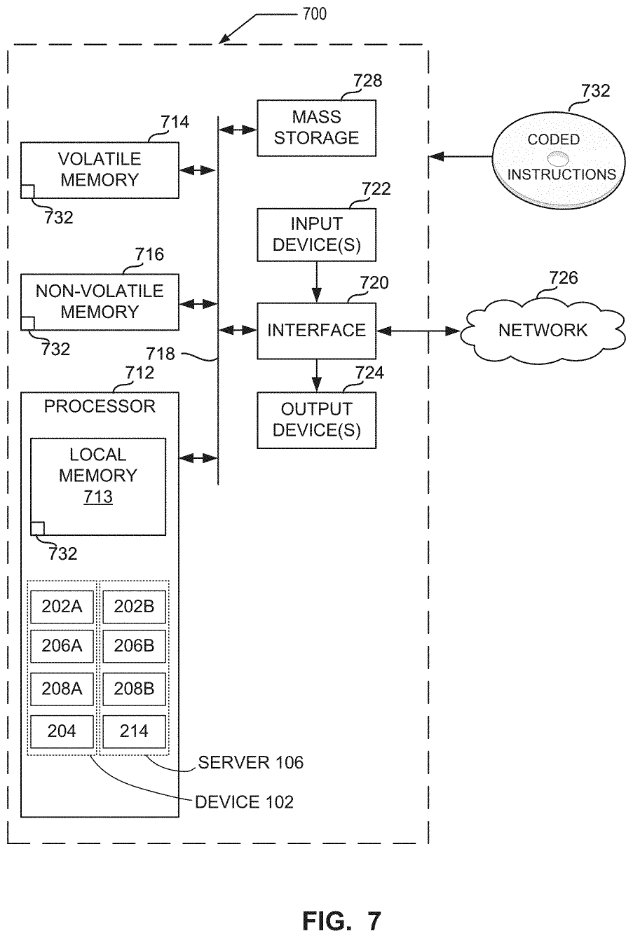

The example frequency scaler circuitry 206A improves the performance of processor circuitry on the example device 102 to execute computationally expensive tasks according to the teachings of this disclosure. In some examples, the processor circuitry is an Intel® Xeon Sapphire Rapids processor. In other examples, the processor circuitry may be implemented by any architecture and maybe developed by any manufacturer. Examples of processor circuitry architectures are discussed further in connection with FIG. 7. To improve the performance of the processor circuitry, the example frequency scaler circuitry 206A determines a number of cores in the processor circuitry, selects a subset of the cores based on a power budget, increases the operating frequency of the subset of cores, and decreases the operating frequency of the remaining cores. In some examples, increasing the operating frequency of a processor core may be referred to as overclocking, and decreasing the operating frequency of a processor core may be referred to as underclocking. The example frequency scaler circuitry 206A is discussed further in connection with FIGS. 4, 5. In some examples, the frequency scaler circuitry 206A is instantiated by processor circuitry executing frequency scaler instructions and/or configured to perform operations such as those represented by the flowchart of FIG. 5.

The subset of cores selected by the example frequency scaler circuitry 206A perform the computationally expensive task. In FIG. 2A, the subset of cores implements at least the example multiplier circuitry 212A. In some examples, the subset of cores additionally includes the example controller circuitry 210A. The example controller circuitry 210 and the example controller circuitry 210A are collectively referred to as the example public key acceleration engine 208A. The example public key acceleration engine 208A performs encryption and decryption tasks for the example device 102 according to the teachings of this disclosure. For example, in FIG. 2A, the example public key acceleration engine 208A encrypts the SRS data generated by the SRS calculator circuitry 204.

Within the example public key acceleration engine 208A, the example controller circuitry 210A manages the execution of various encryption tasks. For example, in FIG. 2A, the example controller circuitry 210A obtains the SRS data from the example SRS calculator circuitry 204 and performs one or more portions of the relevant x25519 algorithms required to encrypt the SRS data. The x25519 algorithms include multiple instances of x25519 modular multiplication. When x25519 modular multiplication is required, the example controller circuitry 210A provides the necessary inputs to the example multiplier circuitry 212A to perform the operation. The example controller circuitry 210A also obtains the results of the x25519 operation, uses them to complete the rest of the x2559 algorithm, and provides the final encrypted SRS data to the example interface circuitry 202A for transmission to the example tower 104A. In some examples, the controller circuitry 210A is instantiated by processor circuitry executing controller instructions and/or configured to perform operations such as those represented by the flowchart of FIG. 5.

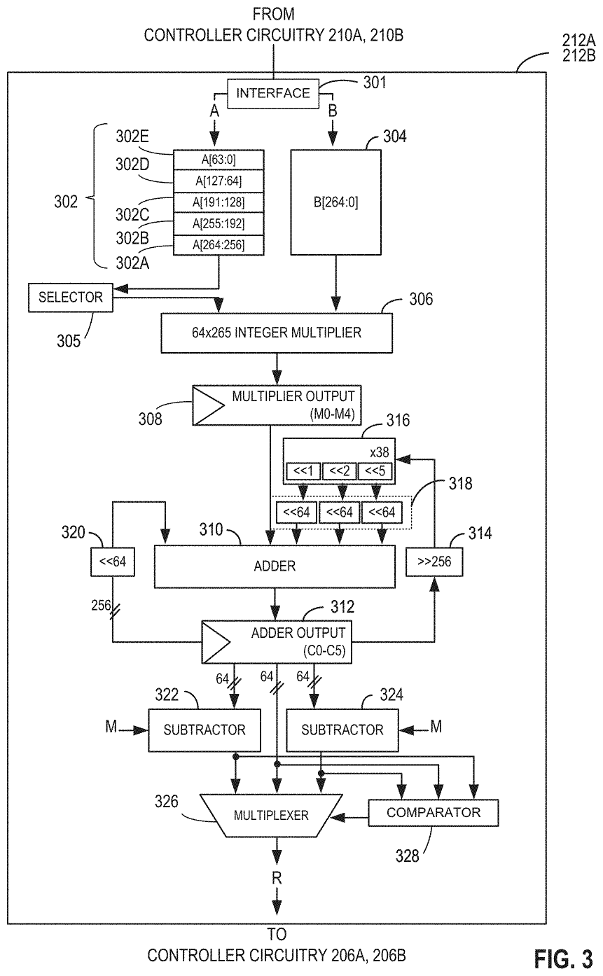

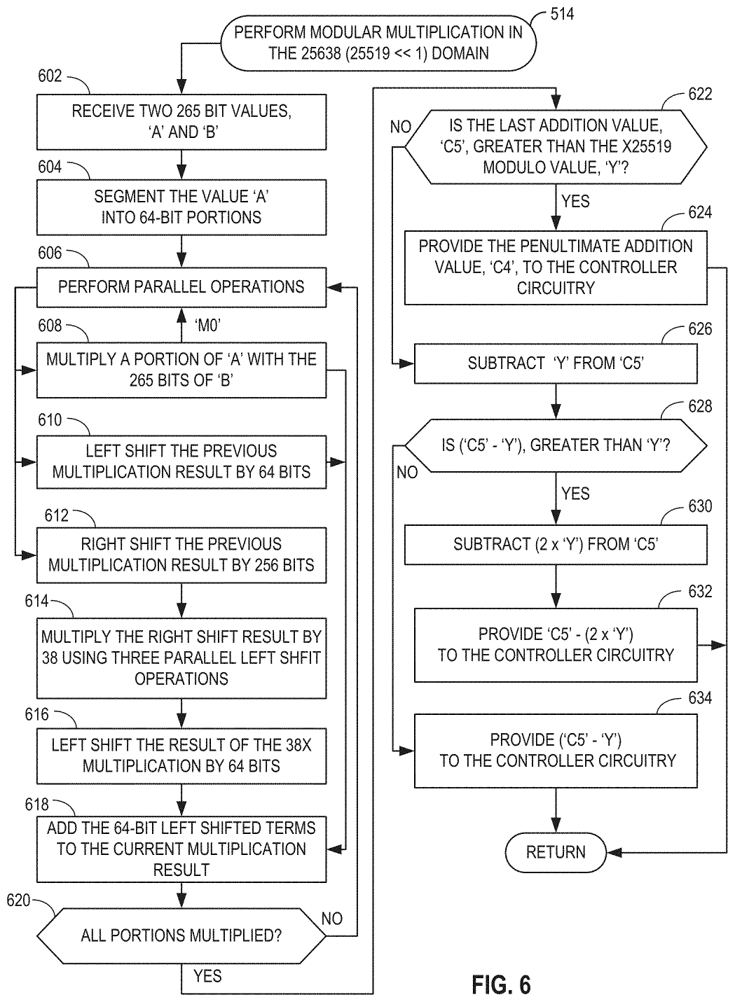

The example multiplier circuitry 212A performs x25519 modular multiplication according to the teachings of this disclosure. In examples described herein, the technique described in this disclosure to perform x25519 modular multiplication may be referred to as modular multiplications in the example 25638 (25519<<1) domain. The example 25638 (25519<<1) domain is discussed further in connection with FIG. 3. In contrast, techniques from previous solutions to perform x25519 modular multiplications may be referred to as modular multiplications in the 25519 domain. The example multiplier circuitry 212A may be operated by one or more cores of processor circuitry that execute instructions at an increased operating frequency as defined by the example frequency scaler circuitry 206A. In some examples, the multiplier circuitry 212A is instantiated by processor circuitry executing multiplier instructions and/or configured to perform operations such as those represented by the flowchart of FIG. 6.

The example block diagram of FIG. 2A shows how the example public key acceleration engine 208A encrypts the SRS data of the illustrative example of FIG. 1. Advantageously, the example multiplier circuitry 212A performs x25519 modular multiplication in the example 25638 (25519<<1) domain rather than the 25519 domain used by previous techniques. As a result, the example multiplier circuitry 212A requires fewer clock cycles to perform x25519 modular multiplication than previous solutions.

Advantageously, the example frequency scaler circuitry 206A instructs the processor circuitry to implement the multiplier circuitry 212A on a subset of the total number of cores in the processor circuitry. The subset may include enough cores to enable parallel operations required in the example 25638 (25519<<1) domain to be executed at requisite performance levels. However, the subset may not include all the cores in the processor circuitry. Because the example device 102 does not perform modular multiplication in the example 25638 (25519<<1) domain on every available core, the example frequency scaler circuitry 206A can reduce the operating frequency on the remaining cores without negatively impacting the performance of the encryption. Reducing the operating frequency of the remaining cores allows the frequency scaler circuitry 206A to increase the frequency of the selected subset of cores without exceeding a power budget. As such, the cores executing modular multiplication in the example 25638 (25519<<1) domain are overclocked so that each clock cycle occurs in a smaller amount of time than clock cycles in cores executing at a standard operating frequency. Therefore, the amount of time required for the multiplier circuitry 212A to compute x25519 modular multiplication is further reduced compared to previous solutions. The reduction of time required to perform x25519 modular multiplication increases the maximum distance the device 102 can be from the example tower 104A while still ensuring that encrypted SRS data does not expire, thereby increasing the coverage and performance of 5G-LTE RANs implemented in accordance with the illustrative example of FIG. 1.

FIG. 2B is an example block diagram of the server of FIG. 1. FIG. 2 includes the example towers 104A, 104B, . . . , 104-n, and the example server 106. The example server 106 includes example interface circuitry 202B, example frequency scaler circuitry 206B, example public key acceleration engine 208B, and example position calculator circuitry 214. The example public key acceleration engine 208B includes example controller circuitry 210B and example multiplier circuitry 212B.

The example interface circuitry 202B enables communication between other components of the example server 106 and external devices. In some examples, the example interface circuitry 202B may implement one or more lower layers of the Open Systems Interconnection (OSI) model for communication protocols that may include, but are not limited to, WiFi®, Bluetooth®, Near Field Communication (NFC), etc. The example interface circuitry 202B receives a computationally expensive task from the external device. In some examples, the interface circuitry 202B is instantiated by processor circuitry executing interface instructions and/or configured to perform operations such as those represented by the flowchart of FIG. 5.

In FIG. 2B, computationally expensive tasks may include but are not limited to the decryption of SRS data and encryption of position data. The example interface circuitry 202B may receive SRS data from both the example device 102 and from a plurality of other devices. In some examples, the example interface circuitry 202B may receive SRS data from thousands of devices. The other devices may communicate with any of the example towers 104A, 104B, . . . , 104-n to receive 5G-LTE positioning data and may be considered additional components of the example computer system 100.

The example frequency scaler circuitry 206B improves the performance of processor circuitry on the example server 106 to perform the computationally expensive tasks. To improve the performance of the processor circuitry, the example frequency scaler circuitry 206B overclocks a subset of processor cores on the example server 106 and underclocks the remaining processor cores following the technique described in connection with the example frequency scaler circuitry 206A of FIG. 2A.

The subset of cores selected by the example frequency scaler circuitry 206B perform the computationally expensive task. In FIG. 2B, the subset of cores implements at least the example multiplier circuitry 212B. In some examples, the subset of cores additionally includes the example controller circuitry 210B. The example controller circuitry 210B and the example multiplier circuitry 212B are collectively referred to as the example public key acceleration engine 208B. The example public key acceleration engine 208B performs encryption tasks for the example server 106 according to the teachings of this disclosure. For example, in FIG. 2B, the example public key acceleration engine 208B decrypts the SRS data provided by the example interface circuitry 202B. The public key acceleration engine 208B may also encrypt the position data provided by the example position calculator circuitry 214.

Within the example public key acceleration engine 208B, the example controller circuitry 210B manages the execution of various encryption tasks. For example, in FIG. 2B, the example controller circuitry obtains the encrypted SRS data from the example interface circuitry 202B and performs one or more portions of the relevant x25519 algorithms required to decrypt the SRS data. The example controller circuitry 210B also provides the decrypted SRS data to the example position calculator circuitry 214, obtains position data from the example position calculator circuitry 214, encrypts the position data using x25519 algorithms, and provides the encrypted position data to the example interface circuitry 202B. The x25519 algorithms include multiple instances of x25519 modular multiplication. When x25519 modular multiplication is required, the example controller circuitry 210B provides the necessary inputs to the example multiplier circuitry 212B to perform the operation.

The example multiplier circuitry 212B performs x25519 modular multiplication according to the teachings of this disclosure. That is, the example multiplier circuitry 212B performs modular multiplication in the in the example 25638 (25519<<1) domain as opposed to the 25519 domain used by previous solutions. In some examples, the multiplier circuitry 212B is instantiated by processor circuitry executing multiplier instructions and/or configured to perform operations such as those represented by the flowchart of FIG. 6.

The example position calculator circuitry 214 determines uses the SRS data for a given device to determine the position of the device. The example position calculator circuitry 214 may additionally use other information to determine position as described previously. The example position calculator circuitry 214 may use any appropriate technique to determine position, including but not limited to triangulation, as described previously.

Advantageously, example frequency scaler circuitry can improve the performance of any number of processor cores to execute computational tasks at any scale. For example, because the example server 106 may perform SRS decryption, position calculation, and position encryption for thousands of devices, the example server 106 may include one or more processor devices that collectively include a multitude of processor cores. The number of processor cores in the example server 106 may be magnitudes greater than the number of processor cores in the example device 102. However, the example frequency scaler circuitry 206A, 206B improve the performance of both the example device 102 and example server 106 respectively so that each component of the example computer system 100 performs x25519 modular multiplication in less time than is required for previous techniques.

Furthermore, the example frequency scaler circuitry 206A, 206B can improve the performance of any processor architecture to execute any type of computational task. In the illustrative example of FIGS. 1, 2A, 2B, the example frequency scaler circuitry 206A, 206B may improve the performance of one or more Intel® Xeon Sapphire Rapids processor to perform x25519 modular multiplication operations in the 25638 (25519<<1) domain. In other examples, the example frequency scaler circuitry 206A, 206B may improve the performance of a different type of processor architecture to execute a different computational task.

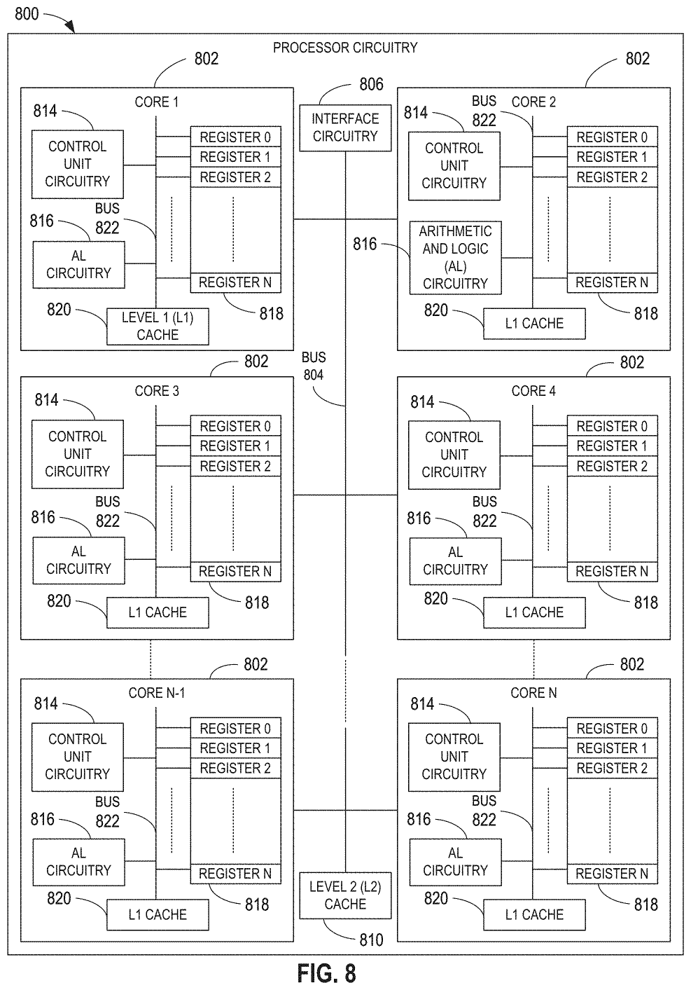

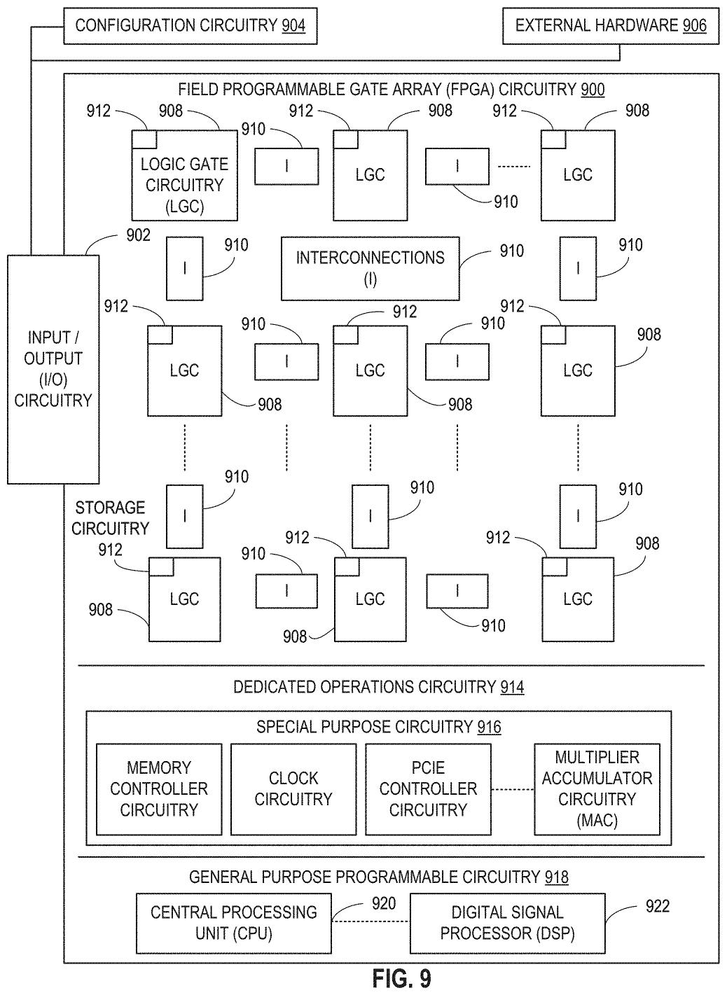

In some examples, both the example device 102 and the example server 106 include means for scaling. For example, the means for scaling may be implemented by frequency scaler circuitry 206A, 206B. In some examples, the frequency scaler circuitry 206A, 206B may be instantiated by processor circuitry such as the example processor circuitry 712 of FIG. 7. For instance, the frequency scaler circuitry 206A, 206B may be instantiated by the example microprocessor 800 of FIG. 8 executing machine executable instructions such as those implemented by at least blocks 502-510 of FIG. 5. In some examples, the frequency scaler circuitry 206A, 206B may be instantiated by hardware logic circuitry, which may be implemented by an ASIC, XPU, or the FPGA circuitry 900 of FIG. 9 structured to perform operations corresponding to the machine readable instructions. Additionally or alternatively, the frequency scaler circuitry 206A, 206B may be instantiated by any other combination of hardware, software, and/or firmware. For example, the frequency scaler circuitry 206A, 206B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

FIG. 3 is an example block diagram of the multiplier circuitry of FIGS. 2A, 2B. The example block diagram of FIG. 3 may be used to implement one or more of the example multiplier circuitry 212A, 212B to perform x25519 modular multiplication using the 25638 (25519<<1) domain and in accordance with the teachings of this disclosure. The example multiplier circuitry 212A, 212B each include example interface circuitry 301, example ‘A’ data portions 302A, 302B, 302C, 302D, collectively referred to as example ‘A’ data 302, example ‘B’ data 304, example selector circuitry 305, example 64×265 integer multiplier circuitry 306, example multiplier output 308, example adder circuitry 310, example adder output 312, example right shift circuitry 314, example left shift circuitry 316, 318, 320, example subtractor circuitry 322, 324, example multiplexer circuitry 326, and example comparator circuitry 328.

The x25519 modular multiplication can generally be described by equation (1):

R%Y=(A×B)%Y (1)

In equation (1), A refers to a 265-bit input number, B refers to a 265-bit input number, Y refers to a 255-bit modulus parameter used in all x25519 modular multiplication, and R refers to a 255 bit result. The example interface circuitry 301 receives the values A and B from one of the example controller circuitry 210A, 210B. The example interface circuitry 301 may receive values for A and B based on the portion of an x25519 algorithm executed by the corresponding controller circuitry 210A, 210B.

In FIG. 3, A in equation (1) is represented as example ‘A’ data 302 and is provided to the example multiplier circuitry 212A, 212B from the corresponding example controller circuitry 210A, 210B. Similarly, in FIG. 3, B in equation (1) is represented as example ‘B’ data 304 and is provided to the example multiplier circuitry 212A, 212B from the corresponding example controller circuitry 210A, 210B.

The example selector circuitry 305 selects mutually exclusive subsets of bits from the example ‘A’ data 302 and provides the subset of bits to the example 64×265 integer multiplier circuitry 306. For example, in a first compute cycle, the example selector circuitry 305 may select the example ‘A’ data portion 302A, which contains bits [264:256] of the value A from equation (1), and provide the selection to the example 64×265 integer multiplier circuitry 306. In a second compute cycle, the example selector circuitry 305 may select the example ‘A’ data portion 302B, which contains bits [255:192] of the value A, provide the new selection to the example 64×265 integer multiplier circuitry 306, etc. The example selector circuitry 305 iteratively selects subsets of bits from the example ‘A’ data 302 in subsequent compute cycles until the superset of all subsets provided to the example 64×265 integer multiplier circuitry 306 is all of the example ‘A’ data 302.

The example 64×265 integer multiplier circuitry 306 multiplies all 265 bits in the example ‘B’ data 304 to a portion of the example ‘A’ data 302. Specifically, in a first compute cycle, the example 64×265 integer multiplier circuitry 306 multiplies the example ‘B’ data 304 to example ‘A’ data portion 302A. In a second compute cycle, the example 64×265 integer multiplier circuitry 306 multiplies the example ‘B’ data 304 to the example ‘A’ data portion 302B, etc.

The example multiplier output 308 is an amount of memory that stores the output of the example 64×265 integer multiplier circuitry 306 after each compute cycle. The values stored by the example multiplier output 308 can be described by equations (2), (3), (4), (5), (6):

M₀[273:0]=A[264:256]×B[264:0] (2)

M₁[328:0]=A[255:192]×B[264:0] (3)

M₂[32 8:0]=A[191:128]×B[264:0] (4)

M₃[32 8:0]=A[127:64]×B[264:0] (5)

M₄[328:0]=A[63:0]×B[264:0] (6)

The example multiplier output 308 stores the values M₀, M₁, M₂, M₃, M₄ in subsequent compute cycles. For example, the example multiplier output 308 stores M₀ during a first compute cycle after the 64×265 integer multiplier circuitry 306 performs the operations described in equation (2). The example multiplier output 308 then stores M₁ during a second compute cycle after the 64×265 integer multiplier circuitry 306 performs the operations described in equation (3), etc.

In an example nth compute cycle, the example adder circuitry 310 performs a summation of a value stored in the multiplier output 308 during the nth compute cycle, the output of the example left shift circuitry 318, and output of the example left shift circuitry 320. In turn, the example adder output 312 is an amount of memory that stores the output of the example adder circuitry 310 after each compute cycle. Both of the example left shift circuitry 318, 320 perform operations that use values generated in the (n−1)th compute cycle. Therefore, the initial condition that occurs during the first compute cycle of a x25519 modular multiplication can be described by equation (7):

C₀−M₀ (7)

In equation (7), C₀ is the value stored by the example adder output 312 during the first compute cycle. The values stored by the example adder output 312 during the subsequent compute cycles, which are referred to in FIG. 3 as C₁, C₂, C₃, and C₄ are discussed further below.

In a given compute cycle, the example right shift circuitry 314 right shifts the value stored in the adder output 312 during the previous compute cycle by 256 bits. During a right shift, excess bits shifted off to the right are discarded. If the operand is unsigned, the example right shift circuitry 314 may shift ‘0’ bits in from the left. If the operand is signed, the example right shift circuitry 314 may shift copies of the signed bit in from the left. The example right shift circuitry 314 removes the 256 lest significant bits from the value stored in the adder output 312 during the previous compute cycle. For example, during the second compute cycle, the example right shift circuitry 314 may produce a 274-bit value. In such examples, bits [18:0] of the output of the example right shift circuitry 314 would equal to M₀[273:256], while bits [273:19] of the output would be either ‘0’ or a signed bit. In subsequent operations that use C₁, C₂, C₃, and C₄ as an input, the example right shift circuitry 314 may produce an output that includes a different number of bits.

The example left shift circuitry 316 performs three left shift operations in parallel. The example left shift circuitry 316 obtains the output of the example right shift circuitry 314 and left shifts the output by three different amounts such that the resulting values are mathematically equivalent to a multiplication of the output of the example right shift circuitry 314 by 38. The example left shift circuitry 316 performs the 38 multiplication by leveraging the fact that a single left shift of an operation by n bits is equivalent to multiplying the operand by 2ⁿ. Therefore, the example left shift circuitry 316 performs a first left shift by 1 bit, multiplying the output of the example right shift circuitry 314 by 2, a second left shift by 2 bits, multiplying the output of the example right shift circuitry 314 by 4, and a third left shift by 5, multiplying the output of the example right shift circuitry 314 by 32. When the three results of the example left shift circuitry 316 are summed by the example adder circuitry 310, the result is a multiplication of the example right shift circuitry 314 by 38.

The example left shift circuitry 318 left shifts each output of the example left shift circuitry 316 by 64 bits. In performing the left shift, the example left shift circuitry 318 removes the 64 most significant bits from the output of the example left shift circuitry 316. The output of the example left shift circuitry 318 can be generalized in equation (8):

left shift(318)ₙ=((Cₙ₋₁>>256)×38)<<64 (8)

In equation (8), left shift (318)ₙ refers to the output of the example left shift circuitry 318 during an nth compute cycle, (Cₙ₋₁>>256) is the output of the example right shift circuitry 314 during the nth compute cycle, the multiplication by 38 is performed by the example left shift circuitry 316, and the left shift by 64 bits is performed by the example left shift circuitry 318.

The example left shift circuitry 320 left shifts a portion of the values stored in the example adder output 312 during the previous clock cycle. The output of the example left shift circuitry 320 can be generalized in equation (9):

left shift(320)ₙ=Cₙ₋₁[255:0]<<64 (8)

In equation (9), left shift (320)ₙ refers to the output of the example left shift circuitry 320 during an nth compute cycle, Cₙ₋₁[255:0] refers to the 256 most significant bits of the value stored in the example adder output 312 during the (n−1)th compute cycle. As an initial condition, the example left shift circuitry 320 may not produce an output in the first compute cycle. The example left shift circuitry 320 may perform the left shift operation described in equation (9) in parallel with when the left shift circuitry 318 performs the left shift operation described in equation (8).

In an example nth compute cycle, the example adder circuitry 310 performs a summation of a value stored in the multiplier output 308 during the nth compute cycle, the output of the example left shift circuitry 318, and output of the example left shift circuitry 320. Therefore, not including the initial condition provided in equation (7) or the exit condition described below, the output of the example adder circuitry 310 in intermediate compute cycles can be generalized in equation (10):

Cₙ=((((Cₙ₋₁>>256)×38)+Cₙ₋₁[255:0])<<64)+Mₙ (10)

In the sixth compute cycle, the example adder circuitry 310 determines the value C₅. The value C₅ is determined because in FIG. 3, indexing of the variables C and M begin at 0 while indexing of compute cycles begins at 1. While equation (10) indicates C₅ would be based on a hypothetical M₅ term, in practice, the example 64×265 integer multiplier circuitry 306 does not produce such a M₅ term because each segment of the example ‘A’ data portions 302A, 302B, 302C, 302D, 302E was multiplied to the example ‘B’ data 304 and stored as variables M₀, M₁, M₂, M₃, M₄. Furthermore, because M₅ does not exist, neither of the example left shift circuitry 318, 320 need to left shift their respective inputs to align with M₅. As such, the value computed by the example adder circuitry 310 during the sixth compute cycle, which may also be referred to as an exit condition, is given in equation (11):

C₅=((C₄>>256)×38)+C₄[255:0] (11)

The example subtractor circuitry 322 subtracts the Y parameter from the last value stored in the example adder output 312, C₅. Similarly, the example subtractor circuitry 324 subtracts the term (2×Y) from C₅. Both of the example subtractor circuitry 322, 324 may obtain the static value of Y from the corresponding controller circuitry 210A, 210B, or from a portion of memory within the corresponding one of the example device 102 or server 106.

The example multiplexer circuitry 326 obtains the output of the example subtractor circuitry 322, C₅−Y, the value C₄ from the example adder output 312, and the output of the example subtractor circuitry 324, C₅−2Y. The example multiplexer circuitry 326 provides one of its inputs as R, the result of the example modular multiplication, to the corresponding example controller circuitry 210A, 210B. The example multiplexer circuitry 326 determines which input to provide as R based on comparisons made by the example comparator circuitry 328.

The example 328 obtains the same inputs as the example multiplexer circuitry 326 and performs one or more comparisons in accordance with the teachings of this disclosure and the 25638 (25519<<1) domain to determine which of the previous terms should be provided to the example controller circuitry 210A, 210B as R, the result of the example modular multiplication. The one or more comparisons performed by the example comparator circuitry 328 are described in equation (12):

R=(C₅>Y)?((C₅−Y)>Y?(C₅−2Y):(C₅−Y)):C₄ (12)

Equation (12) indicates that if (C₅≤Y), the example comparator circuitry 328 instructs the multiplexer circuitry 326 to provide R=C₄ to the example controller circuitry 210A, 210B. If (C₅>Y), the example comparator circuitry 328 performs further comparisons. For example, if (C₅−Y)>Y, the example comparator circuitry 328 instructs the multiplexer circuitry 326 to provide R=(C₅−2Y) to the example controller circuitry 210A, 210B. However, if (C₅−Y)≤Y, the example comparator circuitry 328 instructs the multiplexer circuitry 326 to provide R=(C₅−Y) to the example controller circuitry 210A, 210B.

Advantageously, the example multiplier circuitry 212A, 212B breaks the first multiplication of A×B into partial multiplications and computes the reduction steps in parallel. For example, one of the reduction steps for modular multiplication includes multiplication of (Cₙ₋₁>>256) by an integer. Modular multiplication in the example 25638 (25519<<1) domain includes a multiplication by 38 for the reduction step because 38 can be decomposed into 2¹+2²+2⁵. As a result, multiplication by 38 can be computed by three left shift operations in parallel. In contrast, modular multiplication in the previous 25519 domain may not use parallel bit shift operations to compute a multiplication by 19. As a result, previous solutions to perform modular multiplication may perform more operations sequentially during the reduction step than the example multiplier circuitry 212A, 212B. Accordingly, previous solutions may require longer amounts of time to perform the reduction step than the example multiplier circuitry 212A, 212B.

Advantageously, in the example 25638 (25519<<1) domain, shift and add operations are also calculated in parallel with the partial multiplications. As a result, the example multiplier circuitry 212A, 212B can perform the x25519 modular multiplication given by equation (1) in six compute cycles as described in Table 1 below.

TABLE 1
example 25638 (25519 << 1) domain

| | | Cycles |
|---|---|---|
| Cycle # | Operation | Required |
| 1 | M₀[273:0] = A[264:256] × B[264:0] | 1 |
| | C₀ = M₀ | |
| 2 | M₁[328:0] = A[255:192] × B[264:0] | 1 |
| | C₁ = ((((C₀>>256) × 38) + | |
| | C₀[255:0]) << 64) + M₁ | |
| 3 | M₂[328:0] = A[191:128] × B[264:0] | 1 |
| | C₂ = ((((C₁>>256) × 38) + | |
| | C₁[255:0]) << 64) + M₂ | |
| 4 | M₃[328:0] = A[127:64] × B[264:0] | 1 |
| | C₃ = ((((C₂>>256) × 38) + | |
| | C₂[255:0]) << 64) + M₃ | |
| 5 | M₄[328:0] = A[63:0] × B[264:0] | 1 |
| | C₄ = ((((C₃>>256] × 38) + | |
| | C₃[255:0]) << 64) + M₄ | |
| 6 | C₅ = ((C4 >> 256) × 38) + C₄[255:0] | 1 |
| | R = (C₅ > Y) ? ((C₅ − Y) > Y) ? | |
| | (C₅ − (2 × Y):(C₅ − Y)):C₄ | |

In contrast, the previous solutions that use the 25519 domain may require 19 or more compute cycles to perform x25519 modular multiplication, as described in Table 2 below.

TABLE 2
25519 domain

| | | Cycles |
|---|---|---|
| Cycle # | Operation | Required |
| 1 | M₀[529:0] = A[264:0] × B[264:0] | 6 |
| 7 | M₁[269:0] = M₀[529:265] × 19 | 6 |
| 13 | C₀[279:0] = (M₁[269:0] << 10) + | <<10 |
| | M₀[264:0] | |
| 13+ | M₂[29:0] = C₀[279:255] × 19 | 6 |
| 19+ | C₁[255:0] = M2[29:0] + C₀[254:0] | 1 |
| | R = (C₁ > Y) ? (C₁ − Y):C₁ | |

The example multiplier circuitry 212A, 212B may compute x25519 in fewer compute cycles than previous solutions, improving the efficiency of computationally expensive tasks that include x25519 algorithms. For example, in the example computer system 100, the example device 102 may be positioned further away from the example tower 104A than a second device that use 25519 domain modular multiplication, while the example device 102 and the second device produce unexpired, encrypted SRS data.

In some examples, the example multiplier circuitry 212A, 212B may segment the example ‘A’ data 302 into different portions of data than described previously. In such examples, the number of compute cycles required to compute modular multiplication in the 25638 (25519<<1) domain may be a value other than six. For example, multiplier circuitry 212A, 212B that segments the example ‘A’ data into n segments may compute modular multiplication in the 25638 (25519<<1) domain using (n+1) compute cycles.

In some examples, both the example device 102 and the example server 106 include means for receiving a first value and a second value. For example, the means for receiving may be implemented by interface circuitry 301. In some examples, the interface circuitry 301 may be instantiated by processor circuitry such as the example processor circuitry 712 of FIG. 7. For instance, the interface circuitry 301 may be instantiated by the example microprocessor 800 of FIG. 8 executing machine executable instructions such as those implemented by at least blocks 602 of FIG. 6. In some examples, the interface circuitry 301 may be instantiated by hardware logic circuitry, which may be implemented by an ASIC, XPU, or the FPGA circuitry 900 of FIG. 9 structured to perform operations corresponding to the machine readable instructions. Additionally or alternatively, the interface circuitry 301 may be instantiated by any other combination of hardware, software, and/or firmware. For example, the interface circuitry 301 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, both the example device 102 and example server 106 include means for selecting a subset of bits. For example, the means for selecting may be implemented by selector circuitry 305. In some examples, the selector circuitry 305 may be instantiated by processor circuitry such as the example processor circuitry 712 of FIG. 7. For instance, the selector circuitry 305 may be instantiated by the example microprocessor 800 of FIG. 8 executing machine executable instructions such as those implemented by at least blocks 604 of FIG. 6. In some examples, the selector circuitry 305 may be instantiated by hardware logic circuitry, which may be implemented by an ASIC, XPU, or the FPGA circuitry 900 of FIG. 9 structured to perform operations corresponding to the machine readable instructions. Additionally or alternatively, the selector circuitry 305 may be instantiated by any other combination of hardware, software, and/or firmware. For example, the selector circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, both the example device 102 and the example server 106 include means for multiplying. For example, the means for multiplying may be implemented by 64×265 integer multiplier circuitry 306. In some examples, the 64×265 integer multiplier circuitry 306 may be instantiated by processor circuitry such as the example processor circuitry 712 of FIG. 7. For instance, the 64×265 integer multiplier circuitry 306 may be instantiated by the example microprocessor 800 of FIG. 8 executing machine executable instructions such as those implemented by at least blocks 608 of FIG. 6. In some examples, the 64×265 integer multiplier circuitry 306 may be instantiated by hardware logic circuitry, which may be implemented by an ASIC, XPU, or the FPGA circuitry 900 of FIG. 9 structured to perform operations corresponding to the machine readable instructions. Additionally or alternatively, the 64×265 integer multiplier circuitry 306 may be instantiated by any other combination of hardware, software, and/or firmware. For example, the 64×265 integer multiplier circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, both the example device 102 and example server 106 include means for performing a plurality of bitwise shift operations. For example, the means for performing a plurality of bitwise shift operations may be implemented by right shift circuitry 314, and left shift circuitry 316, 318, 320. In some examples, the right shift circuitry 314, and left shift circuitry 316, 318, 320 may be instantiated by processor circuitry such as the example processor circuitry 712 of FIG. 7. For instance, right shift circuitry 314, and left shift circuitry 316, 318, 320 may be instantiated by the example microprocessor 800 of FIG. 8 executing machine executable instructions such as those implemented by at least blocks 610-616 of FIG. 6. In some examples, the right shift circuitry 314, and left shift circuitry 316, 318, 320 may be instantiated by hardware logic circuitry, which may be implemented by an ASIC, XPU, or the FPGA circuitry 900 of FIG. 9 structured to perform operations corresponding to the machine readable instructions. Additionally or alternatively, the right shift circuitry 314, and left shift circuitry 316, 318, 320 may be instantiated by any other combination of hardware, software, and/or firmware. For example, the right shift circuitry 314, and left shift circuitry 316, 318, 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, both the example multiplier circuitry 212A, 212B includes means for adding. For example, the means for adding may be implemented by adder circuitry 310. In some examples, the adder circuitry 310 may be instantiated by processor circuitry such as the example processor circuitry 712 of FIG. 7. For instance, the adder circuitry 310 may be instantiated by the example microprocessor 800 of FIG. 8 executing machine executable instructions such as those implemented by at least blocks 618 of FIG. 6. In some examples, the adder circuitry 310 may be instantiated by hardware logic circuitry, which may be implemented by an ASIC, XPU, or the FPGA circuitry 900 of FIG. 9 structured to perform operations corresponding to the machine readable instructions. Additionally or alternatively, the adder circuitry 310 may be instantiated by any other combination of hardware, software, and/or firmware. For example, the adder circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, both the example device 102 and the example server 106 include means for comparing. For example, the means for comparing may be implemented by comparator circuitry 328. In some examples, the comparator circuitry 328 may be instantiated by processor circuitry such as the example processor circuitry 712 of FIG. 7. For instance, the comparator circuitry 328 may be instantiated by the example microprocessor 800 of FIG. 8 executing machine executable instructions such as those implemented by at least blocks 622, 628 of FIG. 6. In some examples, the comparator circuitry 328 may be instantiated by hardware logic circuitry, which may be implemented by an ASIC, XPU, or the FPGA circuitry 900 of FIG. 9 structured to perform operations corresponding to the machine readable instructions. Additionally or alternatively, the comparator circuitry 328 may be instantiated by any other combination of hardware, software, and/or firmware. For example, the comparator circuitry 328 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

FIG. 4 is an illustrative example of operations performed by the frequency scaler circuitry of FIGS. 2A, 2B. FIG. 4 includes example cores 402 and an example table 404 to describe frequency scaling within an Intel® Sapphire Rapids processor.

The example frequency scaler circuitry 206A, 206B receives one or more computationally expensive tasks and determines how many of the total number of processor cores in the device can be dedicated to the tasks. The example cores 402 represent the number of cores that the example frequency scaler circuitry 206A, 206B selects to perform the one or more computationally expensive tasks. The example frequency scaler circuitry may determine the number of cores based on a power budget. As used above and herein, a power budget refers to an amount of power that device level software (such as an operating system) determines can be allocated for use to perform the computationally expensive task.

In the illustrative example of FIG. 4, the example cores 402 represent 48 of the 56 total cores that an Intel® Sapphire Rapids processor may implement. In other examples of frequency scaling with other types of processors, the example cores 402 may represent a different portion of a different total number of cores. In the illustrative example of FIG. 4, the example frequency scaler circuitry 206A, 206B further assigns one half of the example cores 402 to execute a first computationally expensive task and assigns the other half of the example cores 402 to execute a second computationally expensive task. The first computationally expensive task of FIG. 4 includes the execution Advanced Vector Extensions (AVX) instruction sets and implement ECC functionality, and the second computationally expensive task of FIG. 4 includes the execution of Streaming SIMD Extensions (SSE) instruction sets.

The example table 404 describes how the example frequency scaler circuitry 206A, 206B increases the operating frequency of the example cores 402 while maintaining a power budget. The x axis of the example table 404 shows relative frequencies that the 24 ECC/AVX dedicated cores could operate at, as well as the power per core that operating at such a frequency would cost. For example, a value of the x axis values of Freq=1.24, p/core=2.341 means that if the example frequency scaler circuitry 206A, 206B overclocks the ECC/AVX dedicated cores to 124% of their normal operating frequency, each of the ECC/AVX cores would consume 234.1% more power than they would if operating at a normal operating frequency. Similarly, the y axis of the example table 404 shows relative frequencies that the 24 SSE dedicated cores could operate at, as well as the power per core that operating at such a frequency would cost.

At the intersection of a first frequency/power combination for the ECC/AVX dedicated cores and a second frequency/power combination for the SSE dedicated cores, the example table 404 includes a value that represents the total amount of power, in Watts, that may be consumed by the Intel® Sapphire Rapids processor. For example, the combination of Freq=1.24, p/core=2.341 for the ECC/AVX dedicated cores and Freq=3.00, p/core=3.903 for the SSE dedicated cores may result in the example processor consuming approximately 184 W of power.

In the illustrative example of FIG. 4, the example Intel® Sapphire Rapids processor is implemented in a device that requires the processor consume 185 W or less at any given time. Therefore, within the example table 404, the example frequency configurations 406 satisfy a power threshold while the example frequency configurations 408 fail to satisfy the threshold. As such, the example frequency scaler circuitry 206A, 206B may overclock the selected 48 cores using any of the example frequency configurations 406. Such frequency configurations decrease the amount of time required to complete the ECC/AVX and SSE operations and also satisfy an example power budget. In some examples, the example frequency scaler circuitry 206A, 206B may also decrease the operating frequency of the nine cores not selected for ECC/AVX or SSE operations to satisfy the example power budget.

While an example manner of implementing the device 102 and server 106 of FIG. 1 is illustrated in FIGS. 2A, 2B respectively, one or more of the elements, processes, and/or devices illustrated in FIGS. 2A, 2B may be combined, divided, re-arranged, omitted, eliminated, and/or implemented in any other way. Further, the example interface circuitry 202A, 202B, the example SRS calculator circuitry 204, the example frequency scaler circuitry 206A, 206B, the example controller circuitry 210A, 210B, the example multiplier circuitry 212A, 212B, the example position calculator circuitry 214, and/or, more generally, the example device 102 and example server 106 of FIG. 1, may be implemented by hardware alone or by hardware in combination with software and/or firmware. Thus, for example, any of the example interface circuitry 202A, 202B, the example SRS calculator circuitry 204, the example frequency scaler circuitry 206A, 206B, the example controller circuitry 210A, 210B, the example multiplier circuitry 212A, 212B, the example position calculator circuitry 214, and/or, more generally, the example device 102 and example server 106 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example device 102 and example server 106 of FIG. 1 may both include one or more elements, processes, and/or devices in addition to, or instead of, those illustrated in FIGS. 2A, 2B, and/or may include more than one of any or all of the illustrated elements, processes and devices.

A flowchart representative of example machine readable instructions, which may be executed to configure processor circuitry to implement the example device 102 and/or the example server 106 of FIGS. 2A, 2B, respectively, is shown in FIG. 5. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 5, many other methods of implementing the example device 102 and/or server 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to efficiently perform a task. The machine readable instructions and/or the operations 500 of FIG. 5 begin when the example interface circuitry 202A, 202B receive a task. (Block 502). In the example device 102, the task may be to provide encrypted SRS data to the example tower 104A before the SRS data expires. In the example server 106, the task may be one or more of decrypting the SRS data, computing position data for the device based on the SRS data, and encrypting the SRS data.

The example frequency scaler circuitry 206A, 206B determines the total number of available cores in the example device 102 and the example server 106, respectively. (Block 504). The number of cores may be included in any type of processor device implemented by the example device 102 and the example server 106. The example number of cores in both the example device 102 and the example server 106 may be any number. In some examples, the example server 106 includes more cores than the example device 102.

The example frequency scaler circuitry 206A, 206B selects a subset of the cores. (Block 506). The subset of cores may be any number of the total available cores. In some examples, the number of cores in the subset may be less than the number of total available cores. In other examples, the example frequency scaler circuitry 206A, 206B may select all of the total available cores at block 506.

The example frequency scaler circuitry 206A, 206B, increases the frequency of the selected cores. (Block 508). With an increased operating frequency, a given compute cycle of the cores selected in block 506 may require less time than the compute cycle would otherwise.

The example frequency scaler circuitry 206A, 206B decreases the frequency of the remaining cores. (Block 510). The example frequency scaler circuitry 206A, 206B decreases the frequency of the remaining cores so that the cores selected in block 506 can be overclocked without exceeding the power budget of the example device 102 or example server 106.

The example frequency scaler circuitry 206A, 206B may use the power budget of the example device 102 and example server 106, respectively, to determine the number of cores that should be in the subset, determine how much the operating frequency of the selected cores should be increased, and determine how much the operating frequency of the remaining cores should be decreased. For example, suppose a hypothetical device using the previous solution to perform encryption and decryption tasks requires 24 cores running at a normal operating frequency to achieve desired performance of x25519 algorithms. Because an example multiplier circuitry 212-n uses approximately ⅓ of the compute cycles required by previous solutions to perform x25519 algorithms, the hypothetical device only requires the 24 cores to run at ⅓ of their normal operating frequency to achieve the same performance if it instead executed x25519 algorithms using the teachings of this disclosure. As a result, an example frequency scaler circuitry 206-n implemented in the hypothetical device may decrease the frequency of the x25519 dedicated cores to ⅓ of its normal operating frequency and increase the operating frequency of other cores dedicated to other tasks. Such a frequency configuration allows the hypothetical device, when performing x25519 algorithms and frequency scaling according to the teachings of this disclosure, to increase the performance of the cores unrelated to encryption and decryption while still meet the desired performance of the x25519 algorithms and still meeting a power budget.

In some examples, a device may implement the example multiplier circuitry 212-n but not the example frequency scaler circuitry 206-n. Accordingly, in such examples, the example machine readable instructions and/or operations does not execute any of blocks 502 through blocks 510 and all cores execute instructions at their normal operating frequency. In such examples, the device is still more efficient than previous solutions to perform x25519 algorithms. In the foregoing example, a hypothetical device using the previous solution to perform encryption and decryption tasks requires 24 cores running at a normal operating frequency to achieve desired performance of x25519 algorithms. If the hypothetical device cannot frequency scale according to the teachings of this disclosure but can switch from the 25519 domain to the 25638 (25519<<1) domain to perform modular multiplication, the hypothetical device will still use approximately ⅓ of the compute cycles than it previously did to perform x25519 algorithms. In such examples, the hypothetical device may, when using the 25638 (25519<<1) domain assign 8 cores running at their normal operating frequency to perform x25519 algorithms and have 16 extra cores to dedicate to other tasks.

Example processor circuitry determines whether the task of block 502 includes x25519 algorithms. (Block 512). In both the example device 102 and the example server 106, the task of block 502 includes x25519 algorithms. However, other examples of devices that implement the frequency scaler circuitry may not execute x25519 algorithms.

If the task of block 502 includes x25519 algorithms (Block 512: Yes), the example multiplier circuitry 212A, 212B performs x25519 modular multiplication in the 25638 (25519<<1) domain as described previously in connection with FIG. 3. (Block 514). The example multiplier circuitry 212A, 212B may perform multiple x25519 modular multiplication operations at block 514. The number of modular multiplication operations performed by the example multiplier circuitry 212A, 212B may depend on the type of x25519 algorithm, the type of input data to the algorithms, etc. The example machine readable instructions and/or operations 500 proceed to block 516 after block 514. Block 514 is discussed further in connection with FIG. 6.

If the task of block 502 does not include x25519 algorithms (Block 512: No), or if there are no further modular multiplications in the x25519 algorithm task, processor circuitry completes the task of block 514. (Block 516). For example, in the example device 102 and example server 106, the example controller circuitry 210A, 210B complete the respective x25519 algorithm tasks. In such examples, one or more of the example controller circuitry 210A, 210B may complete a first portion of the x25519 algorithm, instruct the corresponding multiplier circuitry 212A, 212B to perform a first modular multiplication based on the first portion, complete a second portion of the x25519 algorithm based on the first modular multiplication result, instruct the corresponding multiplier circuitry 212A, 212B to perform a second modular multiplication based on the second portion, etc.

In other examples, processor circuitry implemented by other devices completes other types of tasks during block 516. In such examples, one or more tasks unrelated to x25519 algorithms may include modular multiplication. In such examples, other devices that implement an example multiplier circuitry 212-n may execute the modular multiplication in the 25638 (25519<<1) domain as described previously in connection with FIG. 3. The example machine readable instructions and/or operations 500 end after block 516.

While FIG. 5 is described in connection to the example device 102 and example server 106, the example machine readable instructions and/or operations 500 may be implemented by any device that uses frequency scaling as according to the teachings of this disclosure. As a result, example frequency scaler circuitry may improve the performance of any type of compute device to perform any type of task.

FIG. 6 is a flowchart representative of example machine readable instructions and/or example operations that may be executed by example processor circuitry to implement the 25638 (25519<<1) domain modular multiplication of FIG. 5. Specifically, the flowchart of FIG. 6 shows how the example machine readable instructions and/or operations 500 execute block 514 of FIG. 5.

Execution of block 514 begins when the example interface circuitry 301 receives two 265-bit values, A and B. (Block 602). To perform x25519 modular multiplication, the example multiplier circuitry 212A, 212B may compute A×B % Y as described in the example flowchart of FIG. 6, the example block diagram of FIG. 3, and table 1. In other examples of x25519 modular multiplication, one or more of the values A and B may be composed of a number of bits other than 265.

The example selector circuitry 305 segments the value A into portions. (Block 604). In FIG. 3, the example multiplier circuitry 212A, 212B segments the example ‘A’ data 302 into four portions that each contain 64 bits (such as example ‘A’ data portions 302B, 302C, 302D, 302E) and one portion that contains 9 bits (such as example ‘A’ data portion 302A). In other examples, one or more of the example multiplier circuitry 212A, 212B may segment the example ‘A’ data into different sized portions. In some examples, segmenting the value of A into portions may be referred to as selecting a subset of bits from the value A.

The example multiplier circuitry 212A, 212B performs operations in parallel. (Block 606). Specifically, block 606 refers to the example multiplier circuitry 212A, 212B executing at least blocks 608, 610, 612 in parallel. The example multiplier circuitry 212A, 212B may implement the parallel operations of at least blocks 608, 610, 612 by implementing one or more of blocks 608, 610, 612 on different processor cores. The number of cores that implement both of the example multiplier circuitry 212A, 212B is determined by the example frequency scaler circuitry 206A, 206B respectively in block 506.

The example 64×265 integer multiplier circuitry 306 multiplies a portion of A with the 265 bits of B. (Block 608). The example 64×265 integer multiplier circuitry 306 may use any bitwise multiplication technique to perform the multiplication of block 608.

The example left shift circuitry 320 left shifts the previous multiplication result by 64 bits. (Block 610). After the initial multiplication result (such as M₀ in equation (2)), a previous multiplication result does not yet exist, so the example machine readable instructions and/or instructions 500 proceed from block 608 back to block 606 at the start of a subsequent compute cycle. In examples where the machine readable instructions and/or operations 500 implement block 610 in an nth compute cycle, the previous multiplication result refers to the value produced at block 608 at the (n−1)th compute cycle. In some examples, the example left shift circuitry 320 may left shift the previous multiplication result by a number of bits other than 64. The number of bits left shifted in block 610 may depend on the number of bits in the example ‘A’ data portions 302A, 302B, 302C, 302D, 302E.

The example right shift circuitry 314 right shifts the previous multiplication result by 256 bits. (Block 612). In turn, the example left shift circuitry 316 multiplies the output of block 612 by 38 using three parallel left shift operations. (Block 614). Specifically, the example left shift circuitry 316 simultaneously left shifts the output of block 612 by one bit, left shifts the output of block 612 by two bits, and left shifts the output of block 612 by five bits. In other examples, the example left shift circuitry 316 may multiply the output of block 612 by a value other than 38. In such examples, the example left shift circuitry 316 implements the multiplication by another value through one or more parallel left shift operations.

The example left shift circuitry 318 left shifts the result of the 38× multiplication (i.e., the output of block 614) by 64 bits. (Block 616). As a result, three adder circuitry 310 obtains two terms, the output of block 610 and the output of block 616, that are both left shifted by 64 bits. In examples in which the example left shift circuitry 320 left shifts a number of bits other than 64 at block 610, the example left shift circuitry 318 may correspondingly left shift the output of block 614 by the same number bits at block 616.

The example adder circuitry 310 adds the 64-bit left shifted terms to the current multiplication result. (Block 618). Specifically, during the nth compute cycle, the example adder circuitry 310 adds the outputs of blocks 608, 610, 616 that were executed during the nth compute cycle.

The example multiplier circuitry 212A, 212B determines if all portions of A have been multiplied to B. (Block 620). If all portions of A have not been multiplied to B, (Block 620: No), the example machine readable instructions and/or operations 500 return to block 606, where blocks 608, 610, 612 are implemented in parallel during a subsequent compute cycle. During the subsequent cycle, at block 610, the example 64×265 integer multiplier circuitry 306 multiplies a portion of A that was not used as an input during a previous compute cycle.

If all portions of A have been multiplied to B, (Block 620: Yes), the example multiplier circuitry 212A, 212B determines whether the last addition value of block 618, C₅, is greater than the x25519 modulo value, Y. (Block 622). If C₅ is greater than Y (Block 622: Yes), the example multiplexer circuitry 326 provides the penultimate addition value of block 618, C₄, to the relevant controller circuitry 210A, 210B. (Block 624). The example machine readable instructions and/or operations 500 return to block 516 after block 624.

If C₅ is less than or equal to Y (Block 622: No), the example subtractor circuitry 322 subtracts Y from C₅. (Block 626). The example multiplier circuitry 212A, 212B then determines whether the output of block 626, C₅−Y, is greater than Y. (Block 628).

If C₅−Y is greater than Y (Block 628: Yes), the example subtractor circuitry 324 subtracts (2×Y) from C₅. (Block 630). The example multiplexer circuitry 326 then provides the output of block 630, C₅−(2×Y), to the relevant controller circuitry 210A, 210B. (Block 632). The example machine readable instructions and/or operations 500 return to block 516 after block 632.

If C₅−Y is less than or equal to Y (Block 628: No), the example multiplexer circuitry 326 provides the output of block 626, C₅−Y, to the relevant controller circuitry 210A, 210B. (Block 634). The example machine readable instructions and/or operations 500 return to block 516 after block 634.

FIG. 7 is a block diagram of an example processor platform 700 structured to execute and/or instantiate the machine readable instructions and/or the operations of FIGS. 5, 6 to implement the example device 102 and/or the example server 106 of FIG. 1. The processor platform 700 can be, for example, a server, a personal computer, a workstation, a self-learning machine (e.g., a neural network), a mobile device (e.g., a cell phone, a smart phone, a tablet such as an iPad™), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements one or more of the example SRS calculator circuitry 204, the example frequency scaler circuitry 206A, 206B, the example public key acceleration engine 208A, 208B, and the example position calculator circuitry 214.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIG. 5, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowchart of FIG. 5 to effectively instantiate the example device 102 of FIG. 2A and/or the example server 106 of FIG. 2B as logic circuits to perform the operations corresponding to those machine readable instructions. In some such examples, the example device 102 of FIG. 2A and/or the example server 106 of FIG. 2B is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5, 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5, 6 but whose interconnections and logic circuitry are fixed once fabricated), the FPGA circuitry 900 of the example of FIG. 7 includes interconnections and logic circuitry that may be configured and/or interconnected in different ways after fabrication to instantiate, for example, some or all of the machine readable instructions represented by the flowcharts of FIGS. 5, 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 5, 6. As such, the FPGA circuitry 900 may be structured to effectively instantiate some or all of the machine readable instructions of the flowcharts of FIGS. 5, 6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 5 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIG. 5 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 7 and 8 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 5, 6 may be executed by one or more of the cores 802 of FIG. 8, a second portion of the machine readable instructions represented by the flowcharts of FIGS. 5, 6 may be executed by the FPGA circuitry 900 of FIG. 9, and/or a third portion of the machine readable instructions represented by the flowcharts of FIGS. 5, 6 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

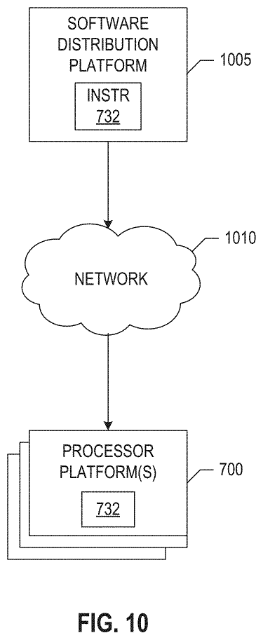

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions and/or example operations 500 of FIG. 5, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions and/or example operations 500 of FIG. 5, may be downloaded to the example processor platform 700, which is to execute the machine readable instructions 732 to implement the example device 102 and/or example server 106. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that improve the performance of encryption tasks. Disclosed systems, methods, apparatus, and articles of manufacture improve the efficiency of using a computing device by selecting a subset of cores within a processor to perform a computational task, increasing the operating frequency of the subsequent cores, and decreasing the operating frequency of the remaining cores. If the computational task includes x25519 modular multiplication, disclosed systems, methods, apparatus, and articles of manufacture improve the efficiency of using a computing device by performing operations in the 25638 (25519<<1) domain. In the 25638 (25519<<1) domain breaks the first multiplication of A×B into partial multiplications, and computes the reduction, shift, and add operations in parallel. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve the performance of encryption tasks are disclosed herein. Further examples and combinations thereof include the following.

Example 1 includes an apparatus to perform a modular multiplication, the apparatus comprising interface circuitry to receive a first value and a second value, selector circuitry to select a first subset of bits and a second subset of bits from the first value, multiplier circuitry to multiply the first subset of bits and the second value during a first compute cycle, and multiply the second subset of bits and the second value during a second compute cycle, left shift circuitry to perform a plurality of bitwise shift operations with a product of the first subset and the second value during the second compute cycle, adder circuitry to add a product of the second subset and the second value to a result of the plurality of bitwise shift operations during the second compute cycle, and comparator circuitry to determine the result of the modular multiplication based on a comparison of a final addition value with a modulo value, the final addition value based on a result of the addition during the second compute cycle.

Example 2 includes the apparatus of example 1, wherein the selector circuitry is further to select a plurality of subsets of bits from the first value, and the multiplier circuitry is further to multiply the plurality of subsets to the second value in respective compute cycles, where one subset is multiplied with the second value per compute cycle.

Example 3 includes the apparatus of example 2, wherein the first subset of bits, second subset of bits, and plurality of subsets of bits are mutually exclusive, and a superset of the first subset of bits, second subset of bits, and plurality of subsets of bits include all the bits in the first value.

Example 4 includes the apparatus of example 1, wherein the left shift circuitry is further to perform a first left shift by 1 bit, a second left shift by 2 bits, and a third left shift by 5 bits, the first left shift, second left shift, and third left shift collectively form a multiplication by 38, and the left shift circuitry is further to perform the first left shift, the second left shift, and the third left shift in parallel.

Example 5 includes the apparatus of example 1, further including frequency scaler circuitry to select, from a set of processor cores, a subset of processor cores, increase an operating frequency of the subset of processor cores, and perform the modular multiplication using the subset of processor cores.

Example 6 includes the apparatus of example 5, wherein the frequency scaler circuitry is further to obtain a power budget, and decrease an operating frequency of processor cores not in the subset to satisfy the power budget.

Example 7 includes the apparatus of example 1, wherein the modular multiplication is part of a Montgomery point multiplication or a Twisted Edwards point multiplication.

Example 8 includes the apparatus of example 1, wherein the modular multiplication is part of an encryption task using Curve 25519 of elliptic curve Diffie-Hellman (ECDH) key agreement scheme.

Example 9 includes the apparatus of example 1, wherein the selector circuitry it to further determine a result of the modular multiplication in an amount of time that satisfies a latency threshold.

Example 10 includes At least one non-transitory machine-readable medium comprising instructions that, when executed, cause at least one processor to at least receive a first value and a second value, select a first subset of bits and a second subset of bits from the first value, multiply the first subset to the second value during a first compute cycle, multiply the second subset to the second value during a second compute cycle, perform a plurality of bitwise shift operations with a product of the first subset and the second value during the second compute cycle, add a product of the second subset and the second value to a result of the plurality of bitwise shift operations during the second compute cycle, and determine the result of a modular multiplication based on a comparison of a final addition value with a modulo value, the final addition value based on a result of the addition during the second compute cycle.

Example 11 includes the at least one non-transitory machine-readable medium of example 10, wherein the instructions, when executed, cause the at least one processor to select a plurality of subsets of bits from the first value, and multiply the plurality of subsets to the second value in respective compute cycles, where one subset is multiplied with the second value per compute cycle.

Example 12 includes the at least one non-transitory machine-readable medium of example 11, wherein the first subset of bits, second subset of bits, and plurality of subsets of bits are mutually exclusive, and a superset of the first subset of bits, second subset of bits, and plurality of subsets of bits include all the bits in the first value.

Example 13 includes the at least one non-transitory machine-readable medium of example 10, wherein the plurality of bitwise shift operations include a first left shift by 1 bit, a second left shift by 2 bits, and a third left shift by 5 bits, the first left shift, second left shift, and third left shift collectively form a multiplication by 38, and execute the first left shift, the second left shift, and the third left shift in parallel.

Example 14 includes the at least one non-transitory machine-readable medium of example 10, wherein the at least one processor includes a set of processor cores, and the instructions, when executed, cause the at least one processor to select a subset of processor cores, increase an operating frequency of the subset of processor cores, and perform the modular multiplication using the subset of processor cores.

Example 15 includes the at least one non-transitory machine-readable medium of example 14, wherein the instructions, when executed, cause the at least one processor to obtain a power budget set corresponding to the processor, and satisfy the power budget by decreasing an operating frequency of processor cores not in the subset.

Example 16 includes the at least one non-transitory machine-readable medium of example 10, wherein the instructions, when executed, cause the at least one processor to compute the modular multiplication as part of a Montgomery point multiplication or a Twisted Edwards point multiplication.

Example 17 includes the at least one non-transitory machine-readable medium of example 10, wherein the instructions, when executed, cause the at least one processor to compute the modular multiplication as part of an encryption task using Curve 25519 of an elliptic curve Diffie-Hellman (ECDH) key agreement scheme.

Example 18 includes the at least one non-transitory machine-readable medium of example 10, wherein the instructions, when executed, cause the at least one processor to compute the modular multiplication in an amount of time that satisfies a latency threshold.

Example 19 includes a method to perform a modular multiplication, the method comprising receiving a first value and a second value, selecting a first subset of bits and a second subset of bits from the first value, multiplying the first subset to the second value during a first compute cycle, multiplying the second subset to the second value during a second compute cycle, performing a plurality of bitwise shift operations with a product of the first subset and the second value during the second compute cycle, adding a product of the second subset and the second value to a result of the plurality of bitwise shift operations during the second compute cycle, and determining the result of the modular multiplication based on a comparison of a final addition value with a modulo value, the final addition value based on a result of the addition during the second compute cycle.

Example 20 includes the method of example 19, further including selecting a plurality of subsets of bits from the first value, and multiplying the plurality of subsets to the second value in respective compute cycles, where one subset is multiplied with the second value per compute cycle.

Example 21 includes the method of example 20, wherein the first subset of bits, second subset of bits, and plurality of subsets of bits are mutually exclusive, and a superset of the first subset of bits, second subset of bits, and plurality of subsets of bits include all the bits in the first value.

Example 22 includes the method of example 19, wherein the plurality of bitwise shift operations include a first left shift by 1 bit, a second left shift by 2 bits, and a third left shift by 5 bits, the first left shift, second left shift, and third left shift collectively form a multiplication by 38, and the method further includes performing the first left shift, the second left shift, and the third left shift in parallel.

Example 23 includes the method of example 19, further including selecting, from a set of processor cores, a subset of processor cores, increasing an operating frequency of the subset of processor cores, and performing the modular multiplication using the subset of processor cores.

Example 24 includes the method of example 23, further including obtaining a power budget, and decreasing an operating frequency of processor cores not in the subset to satisfy the power budget.

Example 25 includes the method of example 19, further including computing the modular multiplication as part of a Montgomery point multiplication or a Twisted Edwards point multiplication.

Example 26 includes the method of example 19, further including computing the modular multiplication as part of an encryption task using Curve 25519 of an elliptic curve Diffie-Hellman (ECDH) key agreement scheme.

Example 27 includes the method of example 19, further including computing the modular multiplication in an amount of time that satisfies a latency threshold.

Example 28 includes an apparatus to perform a modular multiplication, the apparatus comprising means for receiving a first value and a second value, means for selecting to select a first subset of bits and a second subset of bits from the first value, means for multiplying to multiply the first subset to the second value during a first compute cycle, and multiply the second subset to the second value during a second compute cycle, means for performing a plurality of bitwise shift operations with a product of the first subset and the second value during the second compute cycle, means for adding a product of the second subset and the second value to a result of the plurality of bitwise shift operations during the second compute cycle, and means for comparing to determine the result of the modular multiplication based on a comparison of a final addition value with a modulo value, the final addition value based on a result of the addition during the second compute cycle.

Example 29 includes the apparatus of example 28, wherein the means for selecting is further to select a plurality of subsets of bits from the first value, and the means for multiplying is further to multiply the plurality of subsets to the second value in respective compute cycles, where one subset is multiplied with the second value per compute cycle.

Example 30 includes the apparatus of example 29, wherein the first subset of bits, second subset of bits, and plurality of subsets of bits are mutually exclusive, and a superset of the first subset of bits, second subset of bits, and plurality of subsets of bits include all the bits in the first value.

Example 31 includes the apparatus of example 28, wherein the means for performing a plurality of bitwise shift operations is further to perform a first left shift by 1 bit, a second left shift by 2 bits, and a third left shift by 5 bits, the first left shift, second left shift, and third left shift collectively form a multiplication by 38, and the means for performing a plurality of bitwise shift operations is further to perform the first left shift, the second left shift, and the third left shift in parallel.

Example 32 includes the apparatus of example 28, further including means for scaling to select, from a set of processor cores, a subset of processor cores, increase an operating frequency of the subset of processor cores, and perform the modular multiplication using the subset of processor cores.

Example 33 includes the apparatus of example 32, wherein the means for scaling is further to obtain a power budget, and decrease an operating frequency of processor cores not in the subset to satisfy the power budget.

Example 34 includes the apparatus of example 28, wherein the modular multiplication is part of a Montgomery point multiplication or a Twisted Edwards point multiplication.

Example 35 includes the apparatus of example 28, wherein the modular multiplication is part of an encryption task using Curve 25519 of elliptic curve Diffie-Hellman (ECDH) key agreement scheme.

Example 36 includes the apparatus of example 28, wherein the means for comparing is further to determine the result of the modular multiplication in an amount of time that satisfies a latency threshold.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to perform a modular multiplication, the apparatus comprising:
interface circuitry to receive a first value and a second value;
selector circuitry to select a first subset of bits and a second subset of bits from the first value;
multiplier circuitry to:
multiply the first subset of bits and the second value during a first compute cycle; and
multiply the second subset of bits and the second value during a second compute cycle;
left shift circuitry to perform a plurality of bitwise shift operations with a product of the first subset and the second value during the second compute cycle;
adder circuitry to add a product of the second subset and the second value to a result of the plurality of bitwise shift operations during the second compute cycle; and
comparator circuitry to determine the result of the modular multiplication based on a comparison of a final addition value with a modulo value, the final addition value based on a result of the addition during the second compute cycle.

2. The apparatus of claim 1, wherein:
the selector circuitry is further to select a plurality of subsets of bits from the first value; and
the multiplier circuitry is further to multiply the plurality of subsets to the second value in respective compute cycles, where one subset is multiplied with the second value per compute cycle.

3. The apparatus of claim 2, wherein:
the first subset of bits, second subset of bits, and plurality of subsets of bits are mutually exclusive; and
a superset of the first subset of bits, second subset of bits, and plurality of subsets of bits include all the bits in the first value.

4. The apparatus of claim 1, wherein:
the left shift circuitry is further to perform a first left shift by 1 bit, a second left shift by 2 bits, and a third left shift by 5 bits;
the first left shift, second left shift, and third left shift collectively form a multiplication by 38; and
the left shift circuitry is further to perform the first left shift, the second left shift, and the third left shift in parallel.

5. The apparatus of claim 1, further including frequency scaler circuitry to:
select, from a set of processor cores, a subset of processor cores;
increase an operating frequency of the subset of processor cores; and
perform the modular multiplication using the subset of processor cores.

6. The apparatus of claim 5, wherein the frequency scaler circuitry is further to:
obtain a power budget; and
decrease an operating frequency of processor cores not in the subset to satisfy the power budget.

7. The apparatus of claim 1, wherein the modular multiplication is part of a Montgomery point multiplication or a Twisted Edwards point multiplication.

8. The apparatus of claim 1, wherein the modular multiplication is part of an encryption task using Curve 25519 of elliptic curve Diffie-Hellman (ECDH) key agreement scheme.

9. The apparatus of claim 1, wherein the selector circuitry it to further determine a result of the modular multiplication in an amount of time that satisfies a latency threshold.

10. At least one non-transitory machine-readable medium comprising instructions that, when executed, cause at least one processor to at least:
receive a first value and a second value;
select a first subset of bits and a second subset of bits from the first value;
multiply the first subset to the second value during a first compute cycle;
multiply the second subset to the second value during a second compute cycle;
perform a plurality of bitwise shift operations with a product of the first subset and the second value during the second compute cycle;
add a product of the second subset and the second value to a result of the plurality of bitwise shift operations during the second compute cycle; and
determine the result of a modular multiplication based on a comparison of a final addition value with a modulo value, the final addition value based on a result of the addition during the second compute cycle.

11. The at least one non-transitory machine-readable medium of claim 10, wherein the instructions, when executed, cause the at least one processor to:
select a plurality of subsets of bits from the first value; and
multiply the plurality of subsets to the second value in respective compute cycles, where one subset is multiplied with the second value per compute cycle.

12. The at least one non-transitory machine-readable medium of claim 11, wherein:
the first subset of bits, second subset of bits, and plurality of subsets of bits are mutually exclusive; and
a superset of the first subset of bits, second subset of bits, and plurality of subsets of bits include all the bits in the first value.

13. The at least one non-transitory machine-readable medium of claim 10, wherein:
the plurality of bitwise shift operations include a first left shift by 1 bit, a second left shift by 2 bits, and a third left shift by 5 bits;
the first left shift, second left shift, and third left shift collectively form a multiplication by 38; and
execute the first left shift, the second left shift, and the third left shift in parallel.

14. The at least one non-transitory machine-readable medium of claim 10, wherein:
the at least one processor includes a set of processor cores; and
the instructions, when executed, cause the at least one processor to:
select a subset of processor cores;
increase an operating frequency of the subset of processor cores; and
perform the modular multiplication using the subset of processor cores.

15. The at least one non-transitory machine-readable medium of claim 14, wherein the instructions, when executed, cause the at least one processor to:
obtain a power budget set corresponding to the processor; and
satisfy the power budget by decreasing an operating frequency of processor cores not in the subset.

16. The at least one non-transitory machine-readable medium of claim 10, wherein the instructions, when executed, cause the at least one processor to compute the modular multiplication as part of a Montgomery point multiplication or a Twisted Edwards point multiplication.

17. The at least one non-transitory machine-readable medium of claim 10, wherein the instructions, when executed, cause the at least one processor to compute the modular multiplication as part of an encryption task using Curve 25519 of an elliptic curve Diffie-Hellman (ECDH) key agreement scheme.

18. The at least one non-transitory machine-readable medium of claim 10, wherein the instructions, when executed, cause the at least one processor to compute the modular multiplication in an amount of time that satisfies a latency threshold.

19-27. (canceled)

28. An apparatus to perform a modular multiplication, the apparatus comprising:
means for receiving a first value and a second value;
means for selecting to select a first subset of bits and a second subset of bits from the first value;
means for multiplying to:
multiply the first subset to the second value during a first compute cycle; and
multiply the second subset to the second value during a second compute cycle;
means for performing a plurality of bitwise shift operations with a product of the first subset and the second value during the second compute cycle;
means for adding a product of the second subset and the second value to a result of the plurality of bitwise shift operations during the second compute cycle; and
means for comparing to determine the result of the modular multiplication based on a comparison of a final addition value with a modulo value, the final addition value based on a result of the addition during the second compute cycle.

29. The apparatus of claim 28, wherein:
the means for selecting is further to select a plurality of subsets of bits from the first value; and
the means for multiplying is further to multiply the plurality of subsets to the second value in respective compute cycles, where one subset is multiplied with the second value per compute cycle.

30. The apparatus of claim 29, wherein:
the first subset of bits, second subset of bits, and plurality of subsets of bits are mutually exclusive; and
a superset of the first subset of bits, second subset of bits, and plurality of subsets of bits include all the bits in the first value.

31. The apparatus of claim 28, wherein:
the means for performing a plurality of bitwise shift operations is further to perform a first left shift by 1 bit, a second left shift by 2 bits, and a third left shift by 5 bits;
the first left shift, second left shift, and third left shift collectively form a multiplication by 38; and
the means for performing a plurality of bitwise shift operations is further to perform the first left shift, the second left shift, and the third left shift in parallel.

32. The apparatus of claim 28, further including means for scaling to:
select, from a set of processor cores, a subset of processor cores;
increase an operating frequency of the subset of processor cores; and
perform the modular multiplication using the subset of processor cores.

33. The apparatus of claim 32, wherein the means for scaling is further to:
obtain a power budget; and
decrease an operating frequency of processor cores not in the subset to satisfy the power budget.

34. The apparatus of claim 28, wherein the modular multiplication is part of a Montgomery point multiplication or a Twisted Edwards point multiplication.

35-36. (canceled)
